(19) United States
(12) Patent Application Publication
(10) Pub. No.: US 2017/0163787 A1
(43) Pub. Date: Jun. 8, 2017

(54) Method and electronic device for upgrading or downgrading system

(71) Applicants: Le Holdings (Beijing) Co., Ltd., Beijing (CN); Lemobile Information Technology (Beijing) Co., Ltd., Beijing (CN)

(72) Inventor: Shuaiqun XU, Beijing (CN)

(21) Appl. No.: 15/246,535

(22) Filed: Aug. 25, 2016

Related U.S. Application Data
(63) Continuation of application No. PCT/CN2016/089472, filed on Jul. 8, 2016.

(30) Foreign Application Priority Data
Dec. 7, 2015 (CN) 201510888367.6

(51) Int. Cl. H04M 1/725; H04M 7/00

(52) U.S. Cl. CPC H04M 1/72525; H04M 7/0057; H04M 2203/052

(57) ABSTRACT

Disclosed are a method and an electronic device for upgrading or downgrading a system. The method mainly includes: acquiring a system data packet; backing up user data when a data type of the system data packet is determined to be a whole packet type and this system operation is determined to be a system downgrading, wherein the whole packet type indicates that the system data packet is a complete data packet that can be independently used for upgrading or downgrading; and executing the system data packet to implement a system downgrading after the user data are backed up.

### CROSS REFERENCE TO RELATED APPLICATIONS

This application is a continuation of International Application No. PCT/CN2016/089472, filed on Jul. 8, 2016, which is based upon and claims priority to Chinese Patent Application No. 201510888367.6, filed on Dec. 7, 2015, the entire contents of all of which are incorporated herein by reference.

### TECHNICAL FIELD

The present disclosure relates to communications technologies, and more particularly, to a method and an electronic device for upgrading or downgrading a system.

### BACKGROUND

With the development of communications technologies, mobile phone manufacturers continuously improve mobile phone systems and generate system data packets of different versions so that users may choose required versions to change the systems.

In practical application, changing a system includes upgrading and downgrading a system. Upgrading a system refers to converting a low-edition system to a high-edition system, and downgrading a system refers to converting a high-edition system to a low-edition system. Since a high-version system is an improvement of a low-version system, functions of some system applications in the high-version system are more than those of corresponding system applications in the low-version system. Therefore, the high-version system can successfully read user data generated in the low-version system. However, in many cases, the low-version system is unable to successfully read user data generated in the high-version system. As can be seen, after downgrading systems, incompatibility of some applications may often occur. For this reason, some problems may occur when users use mobile phones. For example, it is unable to successfully read certain user data after an application is started, and thus it is impossible to use a function corresponding to the user data. For another example, it is unable to successfully load certain user data that need to be loaded when an application is started, and thus it is impossible to start the application. For still another example, it is unable to successfully load certain user data that need to be loaded when a mobile phone is started, and thus it is impossible to start the mobile phone.

To solve the foregoing problems, a user must restart a system to enter into a system recovery mode to delete all user data so that the current system does not need to read user data generated by a previous system to normally use each function of the current system. However, user data include important information such as telephone numbers, short messages and chatting records of chat software or the like. A larger loss may be caused to users if the information is deleted. Therefore, it is a difficult problem how to avoid losing user data during a system downgrading.

### SUMMARY

The present disclosure provides a method and an electronic device for upgrading or downgrading a system to solve a problem in the prior art that a loss may be caused to a user in case that user data must be deleted because of an incompatibility problem after a system downgrading.

In a first aspect, embodiments of the present disclosure provide a method for upgrading or downgrading a system, implemented by a terminal, including:
acquiring a system data packet;
backing up user data when a data type of the system data packet is determined to be a whole packet type and this system operation is determined to be a system downgrading, where the whole packet type indicates that the system data packet is a complete data packet that can be independently used for upgrading or downgrading; and
executing the system data packet to implement a system downgrading after the user data are backed up.

In a second aspect, embodiments of the present disclosure provide a non-transitory computer-readable storage medium storing executable instructions, wherein the executable instructions are configured to perform any methods for upgrading or downgrading a system mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for upgrading or downgrading a system mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for upgrading or downgrading a system in accordance with some embodiments;

FIG. 2 is a composition block diagram of an apparatus for upgrading or downgrading a system in accordance with some embodiments;

FIG. 3 is a composition block diagram of another apparatus for upgrading or downgrading a system in accordance with some embodiments; and

FIG. 4 is a block diagram of an electronic device which is configured to perform the methods for upgrading or downgrading a system in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

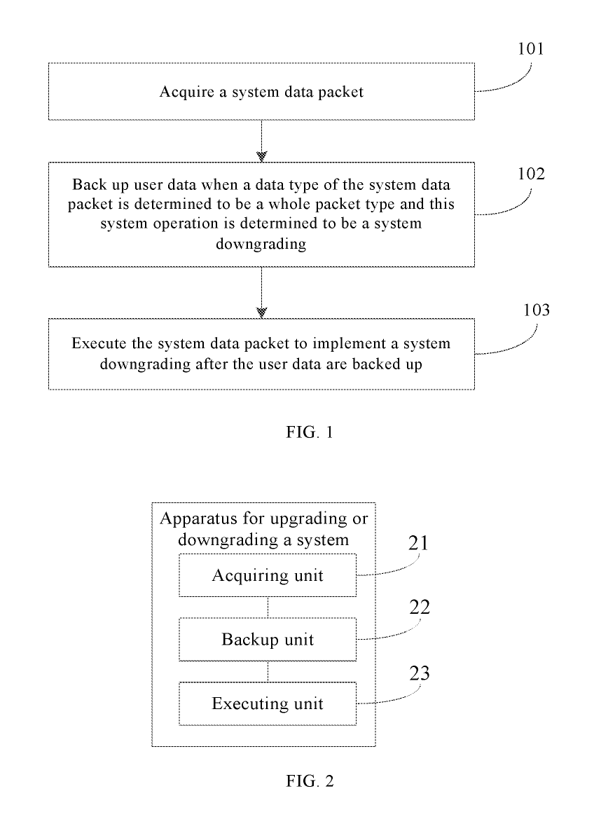

Embodiments of the present disclosure provide a method for upgrading or downgrading a system, as shown in FIG. 1, the method includes following steps.

101: A system data packet is acquired.

When a terminal system needs upgrading or downgrading, a system data packet may be acquired first, and then a subsequent upgrading or downgrading operation is carried out. In practical application, upgrading or downgrading a terminal system includes online upgrading or downgrading a system and offline upgrading or downgrading a system. If a terminal system needs online upgrading or downgrading, the terminal may online download a system data packet via the network. If a terminal system needs offline upgrading or downgrading, a user can download a system data packet on a computer when the terminal is in a shutdown state, and then copy the system data packet to an SD card of the terminal through a data line, thereby acquiring the system data packet. In addition, in practical application a most frequently used system upgrading or downgrading technology is an Over The Air (OTA) technology.

It is to be noted that the terminal may be a mobile phone having an Android system, or a tablet computer having an Android system, or other devices.

102: User data are backed up when a data type of the system data packet is determined to be a whole packet type and this system operation is determined to be a system downgrading.

In practical application, data types of a system data packet include a whole packet type and a differential packet type. The whole packet type indicates that the system data packet is a complete data packet that can be independently used for upgrading or downgrading; the differential packet type indicates that the system data packet is a differential data packet that must be based on a certain version system for upgrading. In other words, a system data packet of a whole packet type not only can implement a system upgrade but also can implement a system downgrading, whereas a system data packet of a differential packet type can only implement a system upgrade.

After system downgrading, a problem of incompatibility between an application and user data may likely be involved, and the user data need to be deleted in order to solve this problem. Therefore, the user data are backed up before the system downgrading to avoid causing a loss to a user after deletion of the user data. After subsequently deleting original user data for solving the incompatibility problem, the user may import the user data backed up into a corresponding application to continue to use.

It is to be noted that when it is required to back up user data, the terminal may automatically execute a backup operation, or may display prompt information so that the user chooses whether to back up the user data.

103: The system data packet is executed to implement a system downgrading after the user data are backed up.

Specifically, the terminal may first enter into a system recovery mode and then execute the system data packet to implement the system downgrading. The system recovery mode is a mode in which system data can be modified. In the mode, a new system can be updated, and an existing system can be backed up, upgraded or downgraded, or restored to factory defaults.

According to the method for upgrading or downgrading a system provided by embodiments of the present disclosure, user data can be backed up and then an acquired system data packet is executed to implement a system downgrading when the data type of the system data packet is determined to be a whole packet type and a local system operation is determined to be a system downgrading, thereby avoiding causing a loss to a user in case that the user data must be deleted to solve a problem of incompatibility between an application and the user data after the system downgrading.

Further, as mentioned in the foregoing Step 102, when it is required to back up user data, the terminal can automatically back up the user data or let a user confirm to back up the user data. A specific implementation of letting a user confirm to back up the user data can be as below: prompt information is displayed, and the user data are backed up after receiving a confirmation backup instruction.

Specifically, the prompt information is used for prompting a user whether to back up the user data. For example, when the terminal determines that this system operation is a downgrading, “An incompatibility problem may likely occur after changing the system, and user data need to be deleted in order to solve this problem, would you please back up the user data before carrying out a subsequent operation?” may be displayed on an interface. After the user clicks to confirm to back up, the terminal may receive a confirmation backup instruction and then back up the user data.

Further, since a high-version system is an improvement of a low-version system, the high-version system is compatible with data produced by the low-version system. In consequence, a system upgrade is not involved with an incompatibility problem, and thus is not involved with deletion of user data. As can be seen, a system data packet is executed to implement a system upgrade when the terminal determines that the data type of the system data packet is a whole packet type and this system operation is a system upgrade, and/or this system operation is determined to be a system upgrade and the system data packet is executed to implement the system upgrade when the terminal determines that the data type of the system data packet is a differential packet type.

It is to be noted that a system data packet of a differential packet type can only implement a system upgrade. Therefore, the terminal can directly determine that this system operation is a system upgrade when the data type of the system data packet is determined to be a differential packet type.

Further, in the present disclosure, when terminal system manufactures develop system data packets, they may add basic information of the system data packets into the developed system data packets so that it is convenient to determine data types and versions of the system data packets according to contents of the basic information subsequently, and to determine whether it is required to back up user data according to the basic information before changing systems by using the system data packets. Therefore, after acquiring a system data packet, the terminal may first acquire a target file from the system data packet, then parse the target file and finally determine the data type of the system data packet according to a parsing result.

The target file is a file that is added in the system data packet and used for describing the basic information of the system data packet when the system data packet is generated; and the basic information includes data type and version information of the system data packet. In practical application, the target file can be a file named as ota_info when upgrading or downgrading a system is implemented through the OTA technology.

Since a system data packet of a whole packet type is a complete data packet that can be independently used for upgrading or downgrading, version information of the system data packet of a whole packet type may only include one version number, namely, the version number of the system data packet. Since a system data packet of a differential packet type is a differential data packet that must be based on a certain version system for upgrading, version information of the system data packet of a differential packet type needs to include two version numbers, namely, an original version number and a target version number. The original version number is used for representing a version number of a system that must be based on for implementing a system upgrade by using the system data packet, namely the version number of the current system of the terminal must be the same as the original version number so that the system data packet can be used for a successful upgrade. The target version number is used for representing a version number of a system that is upgraded by using the system data packet, namely the version number of the system data packet.

It is to be noted that version information of the system data packet of a whole packet type may further include an original version number and a target version number, which are identical, namely the version number of the system data packet.

In addition, the terminal can determine whether this system operation is a system upgrade or a system downgrading by comparing the version number of the system data packet with that of the current system. Specifically, the terminal determines that this system operation to be a system downgrading if the version number of the system data packet is lower than that of the current system. The terminal determines that this system operation to be a system upgrade if the version number of the system data packet is higher than that of the current system.

Further, according to the foregoing method embodiments, another embodiment of the present disclosure further provides an apparatus for upgrading or downgrading a system, which is used in a terminal, as shown in FIG. 2, the apparatus includes: an acquiring unit 21, a backup unit 22 and an executing unit 23.

The acquiring unit 21 is configured to acquire a system data packet.

When a terminal system needs upgrading or downgrading, the acquiring unit 21 may first acquire a system data packet, and then carry out a subsequent upgrading or downgrading operation. In practical application, upgrading or downgrading a terminal system includes online upgrading or downgrading a system and offline upgrading or downgrading a system. If the terminal system needs online upgrading or downgrading, the acquiring unit 21 may online download a system data packet via the network. If the terminal system needs offline upgrading or downgrading, a user can download a system data packet on a computer when the terminal is in a shutdown state, and then copy the system data packet to an SD card of the terminal through a data line. In this way, the acquiring unit 21 acquires the system data packet. In addition, in practical application a most frequently used system upgrading or downgrading technology is an Over The Air (OTA) technology.

The backup unit 22 is configured to back up user data when a data type of the system data packet acquired by the acquiring unit 21 is determined to be a whole packet type and this system operation is determined to be a system downgrading.

The whole packet type indicates that the system data packet is a complete data packet that can be independently used for upgrading or downgrading. In other words, a system data packet of a whole packet type not only can implement a system upgrade but also can implement a system downgrading.

It is to be noted that when the backup unit 22 needs to back up user data, the backup unit 22 may automatically execute a backup operation, or may display prompt information on a terminal interface so that a user chooses whether to back up the user data, and when the user chooses to back up the user data, the backup unit 22 backs up the user data.

The executing unit 23 is configured to execute the system data packet to implement a system downgrading after the backup unit 22 backs up the user data.

Specifically, the terminal may first enter into a system recovery mode and then the executing unit 23 executes the system data packet to implement the system downgrading. The system recovery mode is a mode in which system data can be modified. In the mode, a new system can be updated, and an existing system can be backed up, upgraded or downgraded, or restored to factory defaults.

The apparatus for upgrading or downgrading a system provided by the embodiments of the present disclosure can first back up user data and then execute an acquired system data packet to implement a system downgrading when a data type of the system data packet is determined to be a whole packet type and a local system operation is determined to be a system downgrading, thereby avoiding causing a loss to a user in case that the user data must be deleted because of a problem of incompatibility between an application and the user data after the system downgrading.

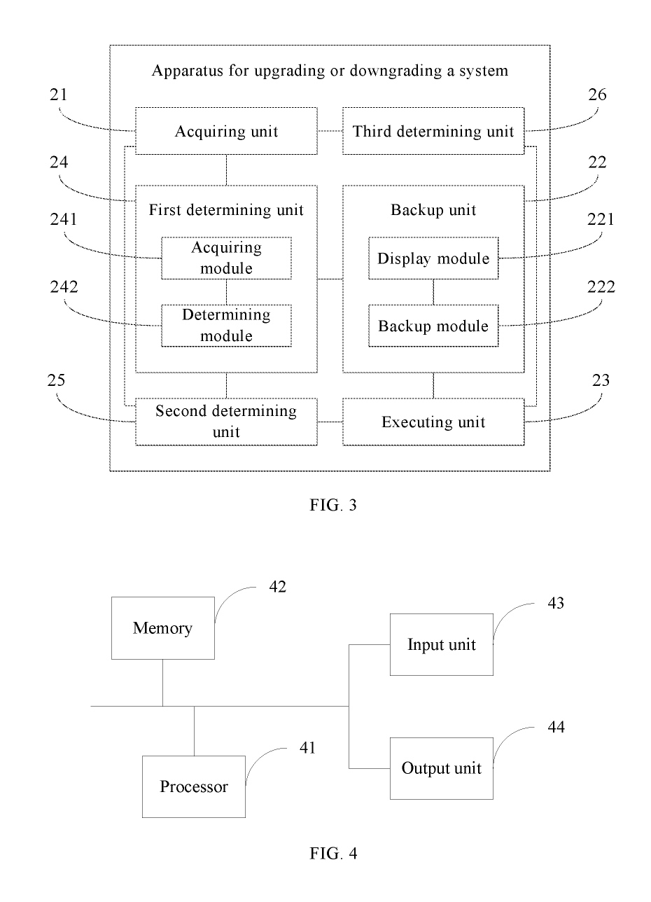

Further, as shown in FIG. 3, the backup unit 22 includes:
a display module 221, configured to display prompt information for prompting a user whether to back up the user data; and
a backup module 222, configured to back up the user data after receiving a confirmation backup instruction.

For example, when the terminal determines that this system operation is a downgrading, the display module 221 may display “An incompatibility problem may likely occur after changing the system, and user data need to be deleted in order to solve this problem, would you please back up the user data before carrying out a subsequent operation?” on an interface. After the user clicks to confirm to back up, the terminal may receive a confirmation backup instruction and then the backup module 222 backs up the user data.

Further, the executing unit 23 is further configured to execute the system data packet to implement a system upgrade when a data type of the system data packet acquired by the acquiring unit 21 is determined to be a whole packet type and this system operation is determined to be a system upgrade, and/or determine this system operation to be a system upgrade and execute the system data packet to implement a system upgrade when a data type of the system data packet acquired by the acquiring unit 21 is determined to be a differential packet type, where the differential packet type indicates that the system data packet is a differential data packet that must be based on a certain version system for upgrading.

Further, as shown in FIG. 3, the apparatus further includes:
a first determining unit 24, configured to determine the data type of the system data packet, where
the first determining unit 24 includes:
an acquiring module 241, configured to acquire a target file from the system data packet, where the target file is a file that is added in the system data packet and used for describing basic information of the system data packet when the system data packet is generated; and
a determining module 242, configured to determine the data type of the system data packet by parsing the target file acquired by the acquiring module 241.

Since a system data packet of a whole packet type is a complete data packet that can be independently used for upgrading or downgrading, version information of the system data packet of a whole packet type may only include one version number, namely, the version number of the system data packet. Since a system data packet of a differential packet type is a differential data packet that must be based on a certain version system for upgrading, version information of the system data packet of a differential packet type needs to include two version numbers, namely, an original version number and a target version number. The original version number is used for representing a version number of a system that must be based on for implementing a system upgrade by using the system data packet, namely the version number of the current system of the terminal must be the same as the original version number so that the system data packet can be used for a successful upgrade. The target version number is used for representing a version number of a system that is upgraded by using the system data packet, namely the version number of the system data packet.

It is to be noted that version information of the system data packet of a whole packet type may further include an original version number and a target version number, which are identical, namely the version number of the system data packet.

Further, as shown in FIG. 3, the apparatus further includes:
a second determining unit 25, configured to determine this system operation to be a system downgrading, where
the second determining unit 25 is configured to determine this system operation to be a system downgrading when a version number of the system data packet is lower than that of a current system.

Further, as shown in FIG. 3, the apparatus further includes:
a third determining unit 26, configured to determine this system operation to be a system upgrade, where
the third determining unit 26 is configured to determine this system operation to be a system upgrade when a version number of the system data packet is higher than that of the current system.

Further, the version number of the system data packet is stored in the target file.

The apparatus embodiment corresponds to the foregoing method embodiment, and for ease of reading, detailed contents in the foregoing method embodiment are not unnecessarily described one by one in the apparatus embodiment. However, it shall be clear that the apparatus in this embodiment can correspondingly implement all the contents in the foregoing method embodiment.

The foregoing apparatus for upgrading or downgrading a system includes a memory and a processor. The foregoing acquiring unit, the backup unit, the executing unit and so on are stored as program units in the memory, and the foregoing program units stored in the memory are executed by the processor to implement corresponding functions.

Further, an embodiment of the present disclosure further provides a non-transitory computer-readable storage medium storing executable instructions, which can be executed by an electronic device to perform any methods for upgrading or downgrading a system mentioned by embodiments of the present disclosure.

FIG. 4 is a block diagram of an electronic device which is configured to perform the methods for upgrading or downgrading a system according to an embodiment of the present disclosure. As shown in FIG. 4, the device includes:
one or more processors 41 and memory 42. A processor 41 is showed in FIG. 4 for an example.

Device which is configured to perform the methods for upgrading or downgrading a system can also include: input unit 43 and output unit 44.

Processor 41, memory 42, input unit 43 and output unit 44 can be connected by BUS or other methods, and BUS connecting is showed in FIG. 4 for an example.

Memory 42 can be used for storing non-transitory software program, non-transitory computer executable program and modules as a non-transitory computer-readable storage medium, such as corresponding program instructions/modules for the methods for upgrading or downgrading a system mentioned by embodiments of the present disclosure (such as shown in FIG. 2, acquiring unit 21, backup unit 22 and executing unit 23). Processor 41 performs kinds of functions and upgrading or downgrading a system of the electronic device by executing non-transitory software program, instructions and modules which are stored in memory 42, thereby realizes the methods for upgrading or downgrading a system mentioned by embodiments of the present disclosure.

Memory 42 can include program storage area and data storage area, thereby the operating system and applications required by at least one function can be stored in program storage area and data created by using the device for upgrading or downgrading a system can be stored in data storage area. Furthermore, memory 42 can include high speed Random-access memory (RAM) or non-volatile memory such as magnetic disk storage device, flash memory device or other non-volatile solid state storage devices. In some embodiments, memory 42 can include long-distance setup memories relative to processor 41, which can communicate with the device for upgrading or downgrading a system by networks. The examples of said networks are including but not limited to Internet, Intranet, LAN, mobile Internet and their combinations.

Input unit 43 can be used to receive inputted number, character information and key signals causing user configures and function controls of the device for upgrading or downgrading a system. Output unit 44 can include a display screen or a display device.

The said module or modules are stored in memory 42 and perform the methods for upgrading or downgrading a system when executed by one or more processors 41.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for upgrading or downgrading a system, implemented by a terminal, comprising:
acquiring a system data packet;
backing up user data when a data type of the system data packet is determined to be a whole packet type and this system operation is determined to be a system downgrading, wherein the whole packet type indicates that the system data packet is a complete data packet that can be independently used for upgrading or downgrading; and
executing the system data packet to implement a system downgrading after the user data are backed up.

2. The method according to claim 1, wherein the backing up user data comprises:
displaying prompt information for prompting a user whether to back up the user data; and
backing up the user data after receiving a confirmation backup instruction.

3. The method according to claim 1, further comprising:
executing the system data packet to implement a system upgrade when a data type of the system data packet is determined to be a whole packet type and this system operation is determined to be a system upgrade; or
determining this system operation to be a system upgrade and executing the system data packet to implement a system upgrade when a data type of the system data packet is determined to be a differential packet type, wherein the differential packet type indicates that the system data packet is a differential data packet that must be based on a certain version system for upgrading.

4. The method according to claim 3, wherein determining a data type of the system data packet comprises:
acquiring a target file from the system data packet, wherein the target file is a file that is added in the system data packet and used for describing basic information of the system data packet when the system data packet is generated; and
parsing the target file to determine the data type of the system data packet.

5. The method according to claim 4, wherein determining this system operation to be a system downgrading comprises:
determining this system operation to be a system downgrading when a version number of the system data packet is lower than that of a current system; and
determining this system operation to be a system upgrade comprises:
determining this system operation to be a system upgrade when a version number of the system data packet is higher than that of the current system.

6. The method according to claim 5, wherein the version number of the system data packet is stored in the target file.

7. A non-transitory computer-readable storage medium storing executable instructions, wherein the executable instructions are configured to:
acquire a system data packet;
back up user data when a data type of the system data packet is determined to be a whole packet type and this system operation is determined to be a system downgrading, wherein the whole packet type indicates that the system data packet is a complete data packet that can be independently used for upgrading or downgrading; and
execute the system data packet to implement a system downgrading after the user data are backed up.

8. The non-transitory computer-readable storage medium according to claim 7, wherein the backing up user data comprises:
displaying prompt information for prompting a user whether to back up the user data; and
backing up the user data after receiving a confirmation backup instruction.

9. The non-transitory computer-readable storage medium according to claim 7, wherein the executable instructions are further configured to:
execute the system data packet to implement a system upgrade when a data type of the system data packet is determined to be a whole packet type and this system operation is determined to be a system upgrade; or
determine this system operation to be a system upgrade and execute the system data packet to implement a system upgrade when a data type of the system data packet is determined to be a differential packet type, wherein the differential packet type indicates that the system data packet is a differential data packet that must be based on a certain version system for upgrading.

10. The non-transitory computer-readable storage medium according to claim 9, wherein determining a data type of the system data packet comprises:
acquiring a target file from the system data packet, wherein the target file is a file that is added in the system data packet and used for describing basic information of the system data packet when the system data packet is generated; and
parsing the target file to determine the data type of the system data packet.

11. The non-transitory computer-readable storage medium according to claim 10, wherein the determining this system operation to be a system downgrading comprises:
determining this system operation to be a system downgrading when a version number of the system data packet is lower than that of a current system; and
the determining this system operation to be a system upgrade comprises:
determining this system operation to be a system upgrade when a version number of the system data packet is higher than that of the current system.

12. The non-transitory computer-readable storage medium according to claim 11, wherein the version number of the system data packet is stored in the target file.

13. An electronic device, comprising:
at least one processor; and
a memory communicably connected with the at least one processor for storing instructions executable by the at least one processor, wherein execution of the instructions by the at least one processor causes the at least one processor to:
acquire a system data packet;
back up user data when a data type of the system data packet is determined to be a whole packet type and this system operation is determined to be a system downgrading, wherein the whole packet type indicates that the system data packet is a complete data packet that can be independently used for upgrading or downgrading; and
execute the system data packet to implement a system downgrading after the user data are backed up.

14. The electronic device according to claim 13, wherein the backing up user data comprises:
displaying prompt information for prompting a user whether to back up the user data; and
backing up the user data after receiving a confirmation backup instruction.

15. The electronic device according to claim 13, wherein the instructions are executed to cause the at least one processor to:
execute the system data packet to implement a system upgrade when a data type of the system data packet is determined to be a whole packet type and this system operation is determined to be a system upgrade; or
determine this system operation to be a system upgrade and execute the system data packet to implement a system upgrade when a data type of the system data packet is determined to be a differential packet type, wherein the differential packet type indicates that the system data packet is a differential data packet that must be based on a certain version system for upgrading.

16. The electronic device according to claim 15, wherein determining a data type of the system data packet comprises:
acquiring a target file from the system data packet, wherein the target file is a file that is added in the system data packet and used for describing basic information of the system data packet when the system data packet is generated; and
parsing the target file to determine the data type of the system data packet.

17. The electronic device according to claim 16, wherein the determining this system operation to be a system downgrading comprises:
determining this system operation to be a system downgrading when a version number of the system data packet is lower than that of a current system; and
the determining this system operation to be a system upgrade comprises:
determining this system operation to be a system upgrade when a version number of the system data packet is higher than that of the current system.

18. The electronic device according to claim 17, wherein the version number of the system data packet is stored in the target file.
